(19) United States
(12) Patent Application Publication
(10) Pub. No.: US 2004/0064722 A1
(43) Pub. Date: Apr. 1, 2004

(54) System and method for propagating patches to address vulnerabilities in computers

(76) Inventors: Dinesh Neelay, Lafayette, CO (US); Sudha Verma, Superior, CO (US)

Correspondence Address: HOGAN & HARTSON LLP, ONE TABOR CENTER, SUITE 1500, 1200 SEVENTEEN ST., DENVER, CO, 80202, US

(21) Appl. No.: 10/262,256

(22) Filed: Oct. 1, 2002

(51) Int. Cl. G06F 11/30

(52) U.S. Cl. 713/200

(57) ABSTRACT

A computer security system and method that includes executing a vaccine program on a computer, where the program searches for a known vulnerability in software on the computer. Upon detecting a vulnerability, the program triggers execution of code that performs at least one non-malicious activity to effect reducing risk associated with the vulnerability, such as generating a notification or applying a software patch to neutralize the vulnerability.

### BACKGROUND OF THE INVENTION

1. Field of the Invention.

The present invention relates, in general, to computer security programs that search for known vulnerabilities in software on computers. The invention also relates to systems, methods and software for diagnosis and remediation of vulnerabilities and distribution of such software

2. Relevant Background.

Computer viruses have evolved from simple computer programs infecting single personal computers via programs on a floppy disk to complex software worms that disrupt wide area computer networks. There are several factors that have lead to the development of ever more disruptive computer viruses including the widespread adoption of homogeneous computing platforms that create large and tempting targets for virus programmers. Also, the increasing sophistication of anti-virus technology has, perhaps ironically, spurred virus programmers to develop increasingly complex viruses that are capable of defeating anti-virus technology and other countermeasures. Moreover, the increasingly widespread knowledge of system vulnerabilities made possible by the Internet has made it significantly easier to create and launch malicious code.

As our increasingly networked computer infrastructures continue to grow and interconnect, so do their vulnerabilities from computer viruses: The global population of computers is becoming increasingly homogeneous allowing a single computer virus to disrupt the functioning of thousands or even millions of computers running substantially identical operating systems. Also, our computers are becoming more programmable than ever before, permitting novice virus developers to create powerful script programming for taking control of the functions of the computer. An increase in the number and variety of software applications has resulted in a corresponding increase in vulnerabilities that can be exploited as well as making it more difficult to detect and filter viruses. Furthermore, increasing homogeneity of software is further reflected in the increasing convergence of hardware and software platforms used by individuals and businesses, permitting virus developers to target both individuals and businesses with the same computer viruses.

In general, a virus is a simple computer program that exploits a vulnerability in a computer operating system, application program, or the like. Typical virus code is configured to discover systems that have a particular vulnerability, trigger the execution of malicious code, and perform some sort of undesirable activity. The undesirable activity can range from behaviors that are merely annoying to behaviors that tie up computer resources or delete files. Virus code typically includes processes that are used to spread itself to other systems by attaching copies of itself to files, identifying network accessible resources to which it can copy itself, and the like. In this manner, the virus code spreads quite efficiently to other systems.

A method for neutralizing computer viruses is to execute an anti-virus program on a computer that searches for known viruses and deletes them upon discovery. An operator typically installs the anti-virus program on the computer through a computer readable magnetic or optical disc purchased from an anti-virus software manufacturer. Alternately, an operator may download and install the anti-virus program from an application provider on the Internet. Similarly, input/output ports used for communication (e.g., e-mail ports) can be continuously monitored to detect and quarantine or delete infected communications.

Another conventional method for neutralizing computer viruses is to install proactively a software patch that corrects a known vulnerability in the computer's software, such as the operating system. The method includes notifying the computer user that a vulnerability exits and a patch for the vulnerability is available. Then, the software patch must be obtained from the software manufacturer and installed on the computer. Significant delays occur in current notification procedures, in addition to delays associated with customer's downloading and installing patches. As a result, even when these software patches are made available, there can be a considerable delay before a computer operator installs a patch. This delay is increasing as the new patches are published with increasing frequency. In some computers, the patches may never be installed. As a result, computers that lack the most recent patches remain vulnerable to attack by a computer virus that would otherwise be neutralized.

Because of delays involved in notification and distribution of patch code, the distribution of software patches is much less efficient than distribution of the virus software. So long as a virus can spread faster than the patches that prevent the virus, the virus will remain a problem. Hence, a need exists for a system and method that notifies computer users of vulnerabilities and/or provides software patches in a manner that approaches or surpasses the efficiency of virus software distribution.

There remains a need in the art for methods of promoting security on a computer network by ensuring software updates, such have software patches, have been installed on a computer in the network. Also, there remain a need in the art for methods of updating software on a computer to ensure that the software is compatible with the most recent versions of other software and files.

### SUMMARY OF THE INVENTION

One embodiment of the invention includes a computer security method comprising executing a program on a computer, wherein the program searches for a known vulnerability in software on the computer. In another embodiment, the method may include alerting an administrator when the known vulnerability is discovered. In still another embodiment, the method may include neutralizing the known vulnerability when discovered on the computer. In yet another embodiment, the method may include propagating the program across a computer network. Optionally, the program in accordance with the present invention may have a limited lifespan or other limit on its ability to propagate.

Another embodiment of the invention includes a computer program product readable by a computer and tangibly embodying instructions executable by the computer to perform a computer security method comprising executing a program on a computer, wherein the program searches for a known vulnerability in software on the computer. In some embodiments the computer program product takes action to diagnose and/or notify and/or remedy the vulnerability.

Another embodiment of the invention includes a computer network comprising a computer, and a program executable by the computer, wherein the program searches for a known vulnerability in software on the computer. The computer network may include a server that propagates the program to the computer. The computer network may also include a communications link that is used to propagate the program between the computer and the server and between the computer and a second computer on the computer network.

### BRIEF DESCRIPTION OF THE DRAWINGS

FIG. 1 shows a flow chart of a computer security method according to an embodiment of the invention;

FIG. 2 shows a flow chart of a computer security method according to another embodiment of the invention;

FIG. 3 illustrates an exemplary computer program product in accordance with the present invention in block-diagram form; and

FIG. 4 shows a simplified computer environment in which the systems, methods, and software in accordance with the present invention are implemented.

### DETAILED DESCRIPTION OF THE PREFERRED EMBODIMENTS

An embodiment of the invention may be thought of as a “digital vaccine” in that it functions to inoculate a host computer system against an attack by a computer virus and other kinds of malicious code. The functions that the digital vaccine performs may include, without being limited to, discovering vulnerabilities on a computer system, triggering the execution of vaccine program code, and preferably taking some action to propagate the vaccine code efficiently to other computer systems that may exhibit the vulnerability. The vaccine program code performs some beneficial or remedial function to aide in eliminating a vulnerability in many cases before the vulnerability can be exploited by a virus.

For example, the vaccine program code may generate a notification message to the operator or an administrator of the computer system, or any other third party, where the notification informs the administrator of a vulnerability that the vaccine has discovered. The notification may simply make the recipient aware of the vulnerability, or may include instructions to patch the vulnerability. The notification may also include instructions that guide the recipient to notify others with similar systems or allow the recipient to spread the vaccine to others.

Alternatively or in addition, the vaccine program code may automatically or semi-automatically install a software patch that neutralizes the vulnerability. A software patch may be downloaded from a network source, or be included inline in the vaccine program code itself. The software patch may be installed with or without interaction of the computer operator to meet the needs of a particular application.

Optionally, the vaccine program code may gather information from the host computer system to help the vaccine recognize and propagate to computer systems that may have a similar vulnerability. For example, the vaccine program code may look for shared network resources (e.g., shared files, shared directories, and the like) and copy itself to those resources. Alternatively, the vaccine program may look at network addresses, address books, or other information that identifies users and computers known to the computer upon which the vaccine is executing. In this manner the vaccine code propagates automatically, semi-automatically, or manually to other computer systems that may be linked to the host computer system via a computer network.

In one embodiment of the invention, substantially all of the functions of the digital vaccine may be performed automatically without asking for permission from a computer administrator. In other embodiments, the computer operator or administrator may be asked whether the digital vaccine should carry out a particular function. For example, the digital vaccine may ask the computer administrator whether the vaccine should install a software patch on the computer system that neutralizes a vulnerability discovered by the vaccine.

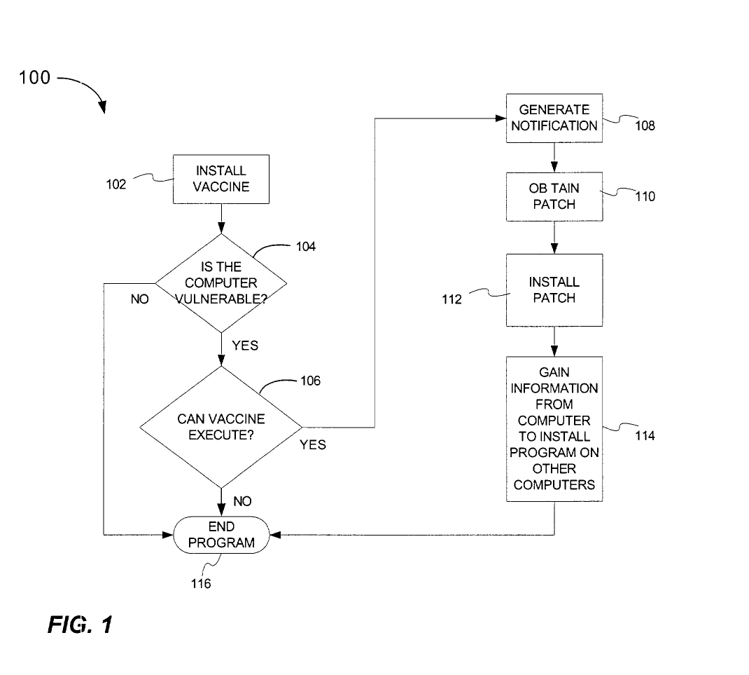

Turning now to FIG. 1, a flow chart of a computer security method 100 according to an embodiment of the present invention is illustrated. In operation 102, a vaccine program in accordance with the present invention is installed on a computer. The vaccine program may be installed on the computer in a number of ways that include downloading from a computer storage medium, such as an optical disc or magnetic floppy disk, and downloading from a remote software server over a computer network such as the Internet. The act of downloading may be explicitly requested by the computer user, or may be implicit as other files are downloaded or, for example, when a web page is viewed. The vaccine code may be attached to or embedded in another file such as an email message, document file, image file, multimedia file, scripts, controls or other available mode for communicating data and/or executable code.

At operation 104. the vaccine program code may include instructions to search for known vulnerabilities on the computer. In an embodiment, the vaccine program may search for known vulnerabilities in the computer by searching for vulnerabilities in software on the computer. Software that the vaccine program may search includes, without being limited to, an operating system, a email program, a word processing program, a spreadsheet program, an Internet browser, networking software, media playing software, Internet Relay Chat software and the like. In general, the applications which exchange data and/or executable code over a network or which expose network interfaces are potential ingress points for virus code and can be examined by vaccine program code in accordance with the present invention.

In an embodiment of the invention, the vaccine program code is self-installing and self-executing such that operations 102 and 104 occur without user intervention. The vaccine program code discovers a system vulnerability by attempting to exploit the vulnerability (e.g., cause a buffer overflow or similar event that creates or indicates a security hole). When the vaccine program does not find any of the known vulnerabilities that it is searching for, the program may terminate at operation 116. When the vaccine program does find a known vulnerability in operation 104, then the program may determine in operation 106 whether it contains executable code that may be executed on software on the computer. If the vaccine program does not have code that can be executed on the computer, then the program may terminate at operation 116.

When the vaccine program does contain code that can be executed on the computer, that code is triggered. The program may execute code in 108 that instructs the computer to notify a user, computer administrator, or other party about the existence of the vulnerability or vulnerabilities. The way that the program informs the computer administrator of a known vulnerability on a computer may include, without being limited to, an email message, a dialog box displayed by the program, an HTML message displayed on a web page, a system message, a log file entry, and the like.

In an embodiment, after, simultaneous with, or instead of notifying the computer administrator that one or more known vulnerabilities exist on the computer, the vaccine program may download a software patch in operation 110 that neutralizes the vulnerabilities when installed and executed on the computer. Once the software patch has been downloaded, the vaccine program may install the patch on the computer in operation 112 to neutralize one or more of the known vulnerabilities. In another embodiment, the vaccine program installed on the computer may include code comprising the software patch that may make it unnecessary to download the patch from an external source, such as a remote server. In another embodiment, a portion of the software patch may be provided by the vaccine program and another portion of the patch may be downloaded from a server.

In an embodiment of the invention, the vaccine program code includes mechanism to propagate itself efficiently to other systems. This may involve obtaining information from the computer about potential vulnerabilities on other computers in operation 114. The information gathered by the vaccine program may include, without being limited to, information on software, such as operating systems, email programs, word processing programs, spreadsheet programs, Internet browsers, networking software, media playing software, Internet Relay Chat software. The information gathered may also include hardware information such as, CPU, memory, chipsets, storage, peripherals, buses, and network interfaces, among others. The information gathered may also include information on the Basic Input Output System (BIOS) of the computer.

In the embodiment of the invention illustrated by FIG. 1, the several steps of security method 100 are shown in sequential order. It should be appreciated that alternate orders for the steps are contemplated by other embodiments of the invention, and that some steps are optional. For example, in another embodiment the steps of downloading 110 and installing a software patch 112 may be simultaneous with, or come after the step of gathering information about the host computer 114. In another embodiment, the step of downloading a software patch 110 may be eliminated if the vaccine program includes code for the software patch. In summary, it is readily recognized by one of skill in the art that that many alternate embodiments of the security method 100 are possible.

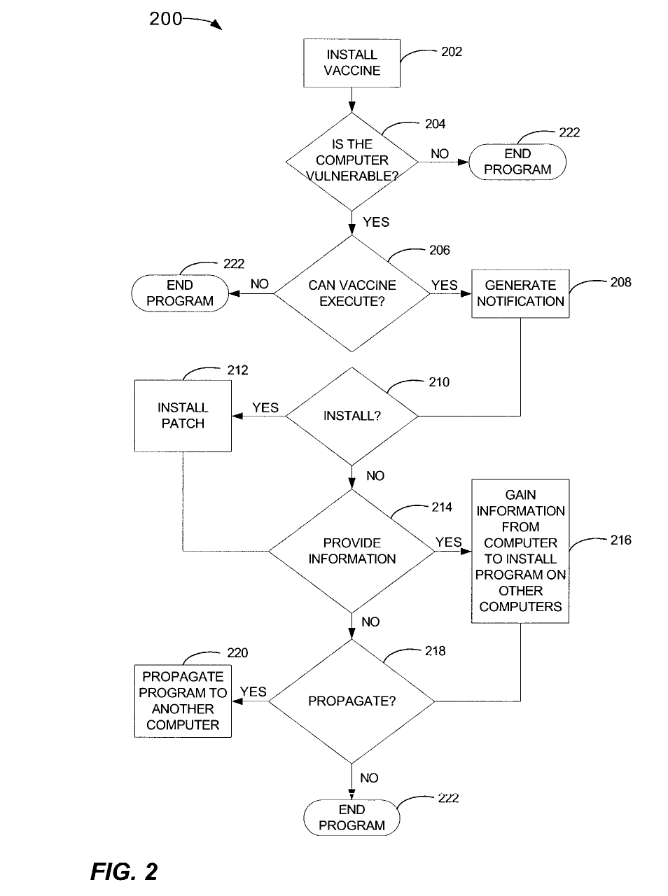

FIG. 2 shows a flow chart of a computer security method 200 according to an embodiment of the invention. The computer security method 200 may include the step of installing a vaccine program on a computer in operation 202. In operation 204, the program may search the computer for vulnerabilities, and if no known vulnerabilities that the program can search for are found, then the program may terminate at 222. Alternately, if vulnerabilities are found, then the vaccine program may search for software on the computer that can it can attach to and execute program code 206. If no such software is found, the vaccine program may terminate 222. Alternatively, if software is found, then the vaccine program may attach to that software and execute program code.

Upon execution of the program code, the vaccine program may notify a computer administrator in operation 208 about vulnerabilities discovered by the vaccine program. In an embodiment of the invention, the vaccine program may inform the computer administrator about a software patch and ask the administrator whether she wishes to install the patch in operation 210. If the computer wishes the vaccine program to install the patch, then the program may install the patch in operation 212. On the other hand, if the administrator does not wish to install the software patch, then the vaccine program may terminate or prompt the administrator for more information.

In an embodiment, the vaccine program may ask the computer administrator in operation 214 whether he wishes to provide information about the computer to the program. When the administrator allows the program to gather information, the program may do so in operation 216. On the other hand, when the administrator denies permission to the vaccine program, then the program may terminate or prompt the administrator for more information.

In an embodiment, the vaccine program may ask the computer administrator whether she wishes to allow the program to propagate from that computer, which may be referred to as the host computer. to one or more other computers that may have network connectivity to the host computer in operation 218. When the administrator allows the vaccine program to propagate, then the program may propagate to one or more other computers in operation 220. On the other hand, when the administrator denies permission to the vaccine program to propagate, then the program may terminate in operation 222 or prompt the administrator for more information.

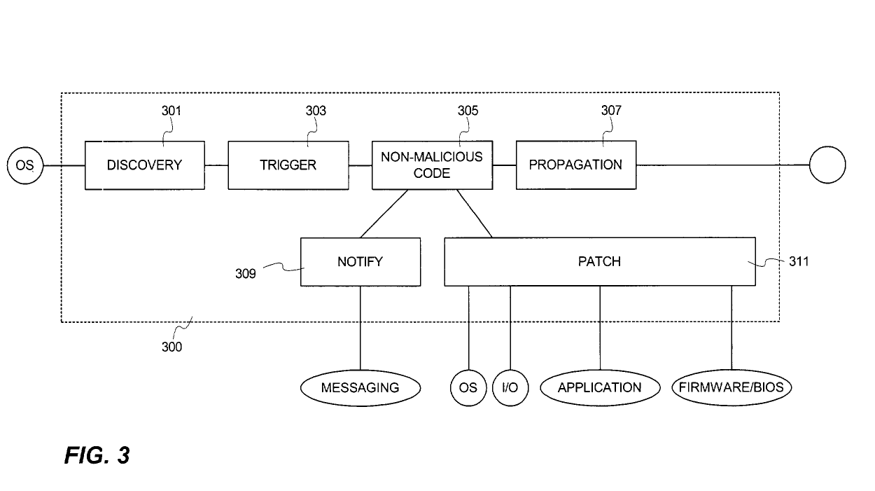

FIG. 3 illustrates an exemplary set of processes that comprise a vaccine program code package 300 in accordance with the present invention. Vaccine 300 includes discovery processes 301 that have an interface to system components (e.g., the operating system) upon which the target security vulnerability might exist. Discovery processes 301 may be self-initializing (e.g., begin execution automatically, or at a certain time, or in response to a system event, or the like). Alternatively, processes 301 may be initialized explicitly.

Discovery processes 301 initialize trigger operations 303 that function to load and being execution of any desired non-malicious code 305. The non-malicious code 305 may communicate with notification processes 309 and/or patch processes 311 as described hereinbefore. Notification processes 309 include an interface to messaging resources such as email, a graphical user interface, or other processes that can be used to communicate with a user, administrator, or other third party. Patch processes 311 includes processes to execute inline patch code, if provided, access input/output (I/O) interfaces to obtain patch software, if needed, as well as interfaces into the installation resource of the operating system, application software, firmware, and/or BIOS resources.

The non-malicious code 305 preferably initializes propagation processes 307 that operate to copy the vaccine in a manner that will efficiently spread the vaccine code. Propagation processes 307 are build with any number and variety of interfaces to computer system components, systems and software that will be needed to spread the vaccine efficiently, preferably at least as efficiently as virus code. In some embodiments propagation processes 307 are implemented with self-limiting processes to mitigate risks associated with excessively aggressive propagation. These self limiting processes may govern the propagation rate, limit the number of times the vaccine program code can propagate, limit the lifetime of the vaccine program code, or otherwise restrict the propagation processes 307. Self-regulating processes may also be implemented in other components of vaccine code 300 such as discovery component 301, and trigger component 303, non-malicious code component 305, as each component affords some opportunity to constrain the functionality of vaccine code 300.

While the modular representation of FIG. 3 suggests strictly defined objects and interfaces, in practice the binary code making up a vaccine program will vary significantly in structure. The actual composition and architecture of a vaccine program may vary significantly to meet the needs of a particular program environment.

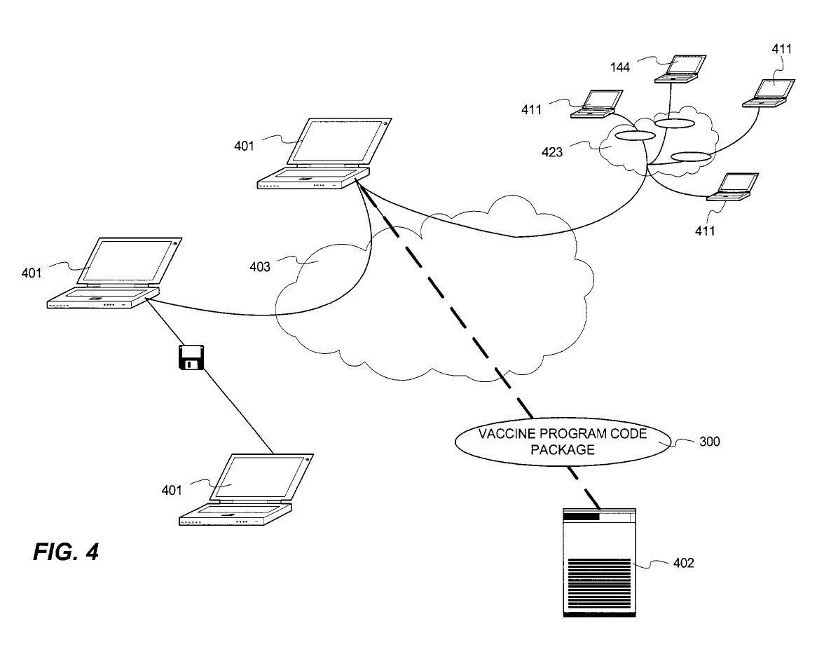

FIG. 4 illustrates a distributed computing environment in which the vaccine system and method of the present invention operate. Various computing systems 401 exist in the environment shown in FIG. 4 and communicate with each other through one or more networks such as networks 403, 413. Moreover, computers communicate with each other through other channels such as sharing files, sharing physical media, or similar non-networked communication methods. The present invention can be implemented across any communication channel that is currently used by virus software to spread from computer to computer.

A server 402 holds an initial copy of a vaccine program code package 301. The vaccine program code package 301 is launched into various computer systems 401. As the vaccine program 301 performs discovery, execution, patching and propagation functions, it spreads amongst various computer systems 401 by network and non-network communication channels. These channels typically enable vaccine 301 to spread between networks, such as to network 413 and computer systems 411.

The systems and methods in accordance with the present invention are readily adapted to detect/diagnose/remedy a variety of computer system issues in addition to vulnerabilities that might be exploited by malicious code. For example, operating systems, drivers, and application software are often updated to address bug fixes, add functionality, remove functionality, and the like. The present invention is adaptable to detect the presence or absence of a particular update and then take some action such as generating a notification about the update, automatically apply or obtain the update, or similar beneficial behavior to meet the needs of a particular application.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. A computer security method comprising executing a program on a computer, wherein the program searches for a known vulnerability in software on the computer.

2. The method of claim 1, comprising alerting an administrator when the known vulnerability is discovered on the computer.

3. The method of claim 1, comprising alerting a third party when the known vulnerability is discovered on the computer.

4. The method of claim 1, comprising neutralizing the known vulnerability when discovered on the computer.

5. The method of claim 4, wherein said neutralizing the known vulnerability comprises installing a software patch into the software.

6. The method of claim 5, wherein said software patch is downloaded from a server.

7. The method of claim 1, comprising propagating the program on a computer network.

8. The method of claim 7, wherein the computer network comprises the Internet.

9. The method of claim 1, wherein the software comprises a computer operating system.

10. A computer program product readable by a computer and tangibly embodying instructions executable by the computer to perform a computer security method comprising executing a program on a computer, wherein the program searches for a known vulnerability in software on the computer and implements at least one non-malicious behavior in response to detection of a vulnerability.

11. The computer program product of claim 10, wherein the computer security method comprises generating a notification when the known vulnerability is discovered on the computer.

12. The computer program product of claim 10, wherein the computer security method comprises neutralizing the known vulnerability when discovered on the computer.

13. The computer program product of claim 10, wherein said neutralizing the known vulnerability comprises installing a software patch into the software.

14. The computer program product of claim 13, wherein said software patch is downloaded from a server.

15. The computer program product of claim 10, wherein the computer security method comprises propagating the program on a computer network.

16. The computer program product of claim 10, wherein the computer network comprises the Internet.

17. The computer program product of claim 10, wherein the software comprises a computer operating system.

18. A computer network comprising a computer having an interface to a communication network, and a program executable by the computer, wherein the program searches for a known vulnerability in software on the computer.

19. The computer network of claim 18, wherein the network comprises a server that propagates the program to the computer.

20. The computer network of claim 19, wherein the program is propagates from the server to the computer through a communications link.

21. The computer network of claim 20, wherein the communications link provides communication between the computer and a second computer, and wherein the program is propagated from the computer to the second computer by the communications link.

22. A method of distributing software updates comprising:
providing program code configured to examine a target computer system for applicability of a software update and take at least one action to effect implementing a particular software update on the computer system;
distributing the program code to the target system;
executing the program code on the target system to examine the target system; and
performing the at least one action on the target system.

23. The method of claim 22 wherein the at least one action comprises generating a notification as to the availability of the particular software update.

24. The method of claim 22 wherein the at least one action comprises installing the particular software update.

25. The method of claim 22 further comprising causing the program code to propagate to at least one computer system other than the target computer system.
